(19) United States
(12) Patent Application Publication
(10) Pub. No.: US 2026/0251260 A1
(43) Pub. Date: Aug. 27, 2026

(54) SECUREMENT DEVICE WITH A MODULAR CLIP SYSTEM

(71) Applicants: Hannah GUO, Sugar Land, TX (US); Hanson GUO, Sugar Land, TX (US); Francis Kok, Sugar Land, TX (US)

(72) Inventors: Hannah GUO, Sugar Land, TX (US); Hanson GUO, Sugar Land, TX (US); Francis Kok, Sugar Land, TX (US)

(21) Appl. No.: 19/061,672

(22) Filed: Feb. 24, 2025

(51) Int. Cl. F16M 13/02; F16B 2/02; F16B 2/20

(52) U.S. Cl. CPC F16M 13/02; F16B 2/02; F16B 2/20

(57) ABSTRACT

A securement device with a modular clip system includes a clamp to releasably secure to a structure; a first clip coupled to the clamp; a second clip to releasably secure to the first clip; and a first connection system to allow the second clip to releasably secure to the first clip.

### FIELD OF THE DISCLOSURE

The disclosure relates generally to securement devices. More specifically, the disclosure relates to a securement device having a modular clip system such that a number and arrangement of clips can vary based on the needs of a user. The present invention is specifically adapted for use securing tubes to a structure, such as a table, as is useful for securing and organizing ventilator tubes, though those skilled in the art will recognize that the invention may be utilized within a plurality of industries without departing from the intent.

### BRIEF SUMMARY OF INVENTION

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere.

In some aspects, the present invention relates to a securement device with a modular clip system, the securement device comprising a clamp configured to releasably secure to a structure; a first clip coupled to the clamp; a second clip configured to releasably secure to the first clip; and a first connection system configured to allow the second clip to releasably secure to the first clip.

In other aspects, the present invention relates to a securement device with a modular clip system, the securement device comprising a first clip having a first connector set and a first receiver; and a second clip having a second connector set and a second receiver. The first clip and the second clip are configured such that they can releasably secure together into two configurations, the two configurations including a vertical configuration wherein the first connector set and the second receiver secure together; and a horizontal configuration wherein the second connector set and the first receiver secure together.

In other aspects, the present invention relates to a securement device with a modular clip system, comprising a plurality of clips, each of the plurality of clips having a connector set positioned on a first surface; and a receiver positioned on a second surface. The connector set of a first of the plurality of clips is configured to releasably secure to the receiver of a second of the plurality of clips. The securement device further includes a clamp configured to releasably secure to the plurality of clips. The plurality of clips are configured to secure into at least two arrangements via the connector set and the receiver of each of the plurality of clips.

### BRIEF DESCRIPTION OF THE SEVERAL VIEWS OF THE DRAWINGS

Illustrative embodiments of the present disclosure are described in detail below with reference to the attached drawing figures.

FIG. 1 is a first perspective view of a securement device with a modular clip system for securing for tubing in accordance with the present invention.

FIG. 2 is a first exploded perspective view of the securement device of FIG. 1.

FIG. 3 is a second exploded perspective view of the securement device of FIG. 1.

FIG. 4 is a second perspective view of the securement device of FIG. 1.

FIG. 5 is a first perspective view showing the securement device of FIG. 1 attached to a table and securing tubes.

FIG. 6 is a second perspective view showing the securement device of FIG. 1 attached to the table and securing tubes.

### List of Reference Numbers

100—Securement Device
102—First Clip
104—Second Clip
106—Third Clip
108—Clamp
110—Bottom Wall
112—Side Wall
114—Top Wall
116—Opening
118—First Pad
120—Second Pad
122—Clamp Release Button
124—Top of Second Clip 104
126—Bottom of Second Clip 104
128—First Release Button for Second Clip 104
130—Hinge of Second Clip 104
132—First Connector Set of Second Clip 104
134—Second Connector Set of Second Clip 104
200—Channel of Second Clip 104
202—Second Release Button for Second Clip 104
204—Top of First Clip 102
206—Bottom of First Clip 102
208—First Connector Set of First Clip 102
210—Second Connector Set of First Clip 102
212—Top of Third Clip 106
214—Bottom of Third Clip 106
216—First Connector Set of Third Clip 106
218—Second Connector Set of Third Clip 106
220a-d—Clip Release Buttons
222—Clamp Connector Set
300—Second Clamp Release Button
302—Hinge of First Clip 102
304—Hinge of Third Clip 106
306—First Receiver
308—Recess
310—Projection
312—Second Receiver
400—Third Receiver
500—Structure
502a-c—Tubes

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Securement devices are well known in the art and provide mechanisms to secure items together. In the medical field, ventilators are common devices used to assist a patient (human or animal) with breathing. Ventilators utilize one or more tubes to provide oxygen or air to the patient. In some systems, multiple tubes may be utilized. Such tubing is generally secured to a structure, such as a table, bed, or other similar structure, such that the tubes are retained in a desired position for optimized use. Some conventional securement devices include tape, alligator clips, or simple clamps, however, these conventional devices have limitations. For example, tape is easily removed, which can result in strain on the tubes and patient discomfort. As another example, in scenarios wherein a plurality of tubes is utilized, it can become cumbersome to secure each tube independently.

The present invention provides for a securement device with a modular clip system configured to overcome the problems discussed above in connection with conventional securement devices for tubes. Those skilled in the art will appreciate that the device may be utilized not only for tubing, but for any similar structure. In addition, the device of the present invention may be used or modified for use in a variety of industries, such as medical, mechanical, household, or in any other applicable industry.

The modular clip system includes a plurality of clips, which can be selectively secured together such that a user can alter the number and orientation of the selected clips, thereby allowing a user to customize the device based on the needs. For example, a user may attach two clips side-by-side, thereby allowing for side-by-side securement of tubes. Alternatively, the user may attach three clips, all vertically, allowing for vertical stacking of tubes. These are only two examples of configurations and the present invention is not limited to any of these examples, nor to a number of clips, as will be discussed in more detail herein.

The present invention provides for a clamp that can secure to a table, bed, or other structure. Again, those skilled in the art will readily appreciate that the clamp may be modified based on aesthetical, functional, or manufacturing considerations. The clamp ensures that the device remains stationary when attached to said structure, until removed by a user.

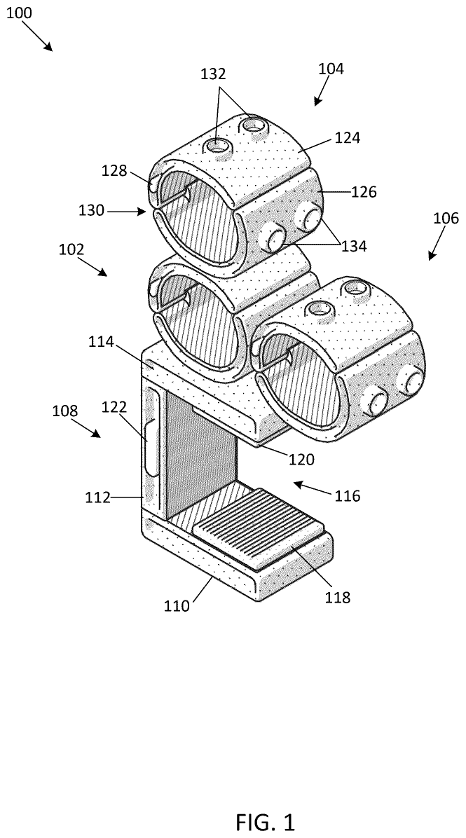

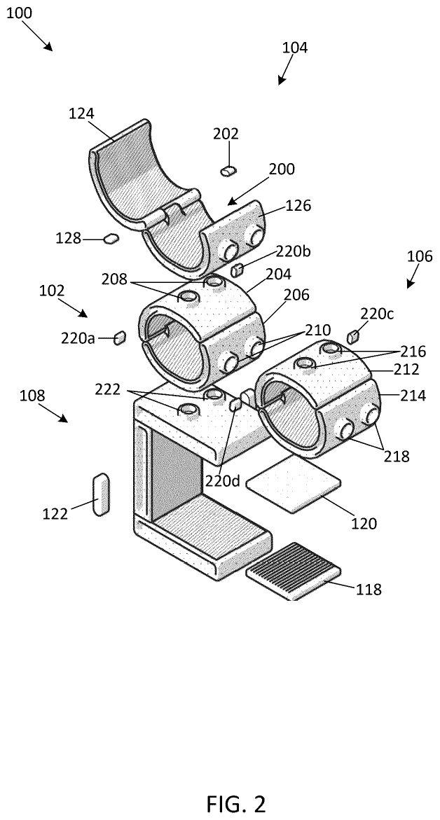

Turning now to FIGS. 1 and 2, perspective views of a securement device 100 are shown. The device 100 includes a plurality of clips, including a first clip 102, a second clip 104, and a third clip 106. Although three clips are shown, the device may be configured with a single clip, two clips, three clips, or additional clips as desired. In this example, the first clip 102 supports the second clip 104 in a vertical orientation and further supports the third clip 106 in a horizontal configuration. As discussed above, the user could decide to secure all three clips vertically or horizontally and could include fewer or more clips based on their needs.

The plurality of clips are attached to a clamp 108. The clamp 108 may vary, but in some embodiments, is spring loaded and shaped via a bottom wall 110, side wall 112, and top wall 114 to form an opening 116 to receive a table or bed or other structure therein. Some embodiments include first and second pads 118, 120 that are textured to increase frictional grip onto a surface. The pads 118, 120 are composed of rubber and provide raised ridges to create the texture and are secured to associated surfaces via adhesives. Further, some embodiments include a clamp release button 122 to release the clamp 108 from the structure. In other words, the clamp 108 will be positioned around a structure and locked into place, such as via a spring-loaded mechanism. As needed, such as for moving or repositioning, the clamp release button 122 can be used to release the clamp 108. The shape and size of the clamp 108 can be easily modified for an intended use. For example, it is contemplated that the opening 116 could be modified in shape and size to appropriately fit various structures within various industries.

The features of the clips may be discussed in detail for one clip of the present application. It will be readily apparent that the teachings discussed for one clip apply to the other clips as well.

As shown, each clip creates a tubular shaped opening or recess. The second clip 104 includes a top 124 and a bottom 126 configured to open and close via any mechanism reasonable in the art to form a channel 200. For example, first and second release buttons 128, 202 may be used to release the second clip 104 from a closed position (FIG. 1) to an open position (FIG. 2). The top 124 and bottom 126 are connected via a hinge 130 to allow the clip 104 to open and receive a tube therein. Again, the size and exact shape can vary based on aesthetical, functional, or manufacturing considerations.

The plurality of clips are modular in design, wherein the plurality of clips utilize a plurality of connection systems to connect to one another. In the preferred embodiment, each clip includes two connector sets and two receivers. Specifically, each clip includes a top pair of connectors, a side pair of connectors, a bottom receiver, and a side receiver. This allows the clips to selectively secure into a plurality of configurations.

Looking at FIG. 1, the second clip 104 demonstrates a first connector set 132 and a second connector set 134. Each connector set comprises two circular studs extending outward from an associated surface. Looking at FIG. 2, the first clip 102, having a top 204 and a bottom 206, also includes a first connector set 208 and a second connector set 210. The third clip 106 also includes a top 212 and a bottom 214, respectively supporting a first connector set 216 and a second connector set 218. As discussed above, clip release buttons 220a-d can be used to release associated clips from their closed position into their open position.

The clamp 108 also includes a connector set 222 composed of two studs extending upward. This allows for one of the plurality of clips (the first clip 102 in the examples shown) to removably secure to the clamp 108. Although not shown, a receiver (the details of which are discussed later herein) is positioned on the bottom side of the first clip 102, such that the receiver and the clamp connector set 222 releasably lock together via a pressure fit.

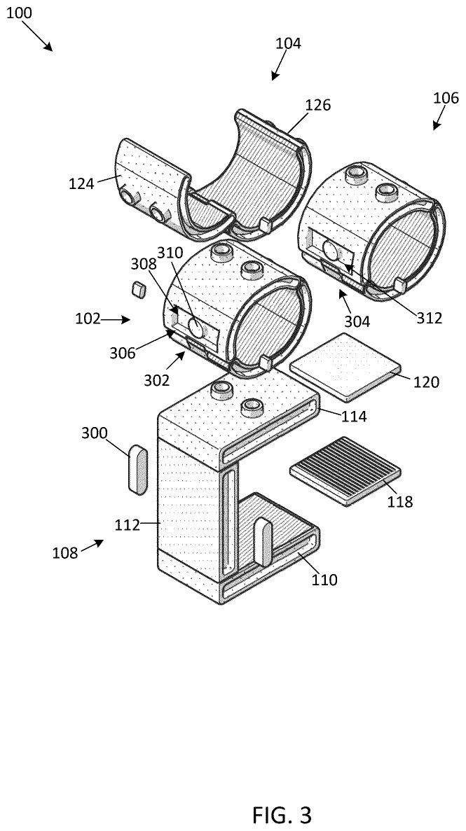

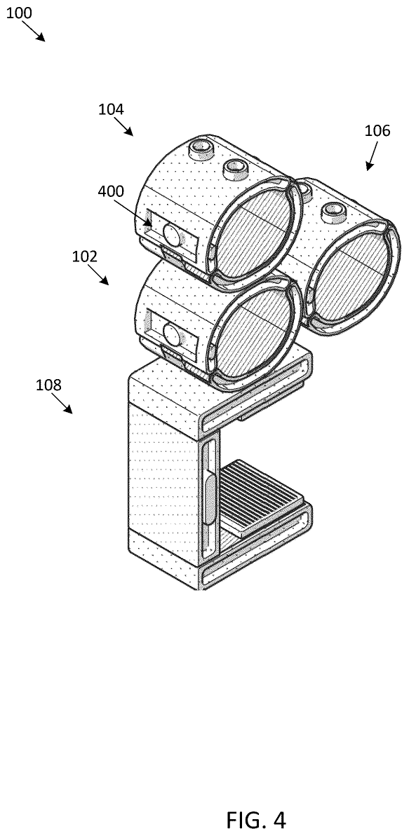

Moving on to FIGS. 3 and 4, alternative perspective views of the securement device 100 are shown. This angle better demonstrates a second clamp release button 300, as well as a hinge 302 of the first clip 102, and a hinge 304 of the third clip 106. These figures also best demonstrate the receivers as part of each of the connection systems. Again, although not every feature is labeled and described, the teachings for any clip can be applied to the remaining clips. As shown, the first clip 102 includes a first receiver 306. Although the type and style of the connectors and receivers may vary, the preferred embodiment of the first receiver 306 comprises a recess 308 and a projection 310. The recess 308 is rectangular in shape and the projection 310 extends outward in the middle of the recess 308. This creates space around the projection 310 and within the recess 308 into which a corresponding connector set will extend into. This creates a pressure hold between the connectors and the receiver. FIGS. 3 and 4 further demonstrate a second receiver 312 as part of the third clip 106 and a third receiver 400 as part of the second clip 104. Again, because each clip includes two connector sets and two receivers, the clips can secure into a plurality of arrangements, including additional or fewer clips than shown.

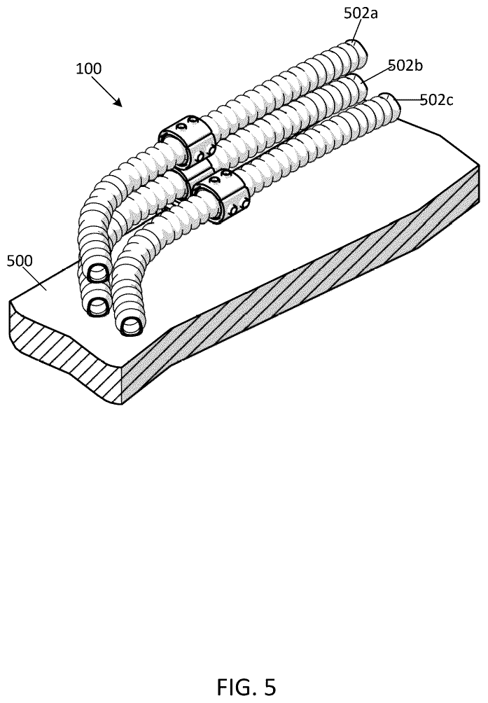

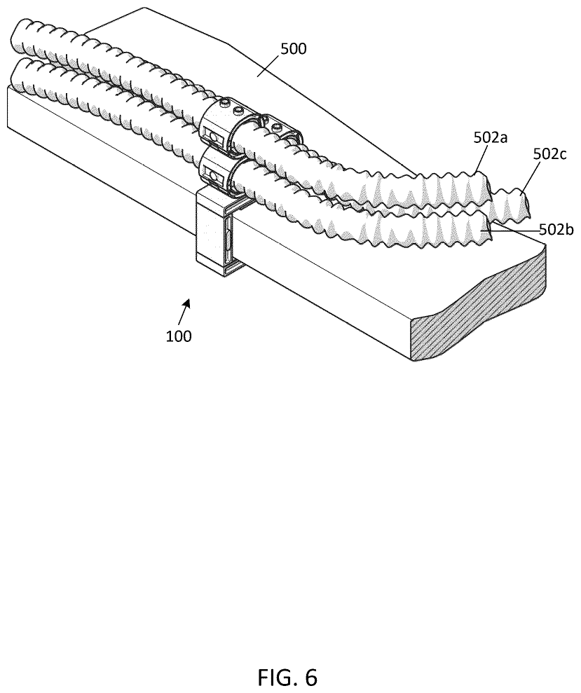

Finaly, turning to FIGS. 5 and 6, two views depict device 100 secured to a structure 500, such as a table, via clamp 108. The clips 102, 104, 106 retain tubes 502a-c therein such that the tubes are secured to the structure.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

1. A securement device with a modular clip system, the securement device comprising:
a clamp configured to releasably secure to a structure;
a first clip coupled to the clamp;
a second clip configured to releasably secure to the first clip; and
a first connection system configured to allow the second clip to releasably secure to the first clip.

2. The securement device of claim 1, wherein the first connection system further comprises:
a first connector set as part of the first clip; and
a first receiver as part of the second clip;
wherein the first connector set and the first receiver are configured to releasably secure together.

3. The securement device of claim 2, wherein the first connector set further comprises two studs extending from a first surface of the first clip, the two studs configured to extend into the first receiver such that a pressure hold retains the two studs within the first receiver.

4. The securement device of claim 3, wherein the first receiver further comprises a recess with a projection extending within the recess.

5. The securement device of claim 1, further comprising a second connection system, the second connection system having a first connector set extending from a top surface of the clamp, the first connector set configured to releasably secure to the first clip.

6. The securement device of claim 1, wherein the first clip further comprises a top and a bottom connected via a hinge, the top and bottom configured to open and close together.

7. The securement device of claim 1, further comprising a third clip configured to removably secure to either of the first clip or the second clip via a second connection system.

8. The securement device of claim 1, wherein the first connection system is positioned such that the first clip and the second clip secure together horizontally.

9. The securement device of claim 1, wherein the first connection system is positioned such that the first clip and the second clip secure together vertically.

10. The securement device of claim 1, wherein each of the first clip and the second clip create a channel configured to receive and retain a tube therein.

11. A securement device with a modular clip system, the securement device comprising:
a first clip having a first connector set and a first receiver; and
a second clip having a second connector set and a second receiver;
wherein the first clip and the second clip are configured such that they can releasably secure together into two configurations, the two configurations including:
a vertical configuration wherein the first connector set and the second receiver secure together; and
a horizontal configuration wherein the second connector set and the first receiver secure together.

12. The securement device of claim 11, further comprising a third clip having a third connector set and a third receiver, wherein:
the third connector set is configured to optionally secure to either of the first receiver or the second receiver; and
wherein the third receiver is configured to optionally receive either of the first connector set or the second connector set.

13. The securement device of claim 12, wherein each of the first connector set, the second connector set, and the third connector set comprises two studs protruding outward.

14. The securement device of claim 12, wherein each of the first receiver, second receiver, and third receiver comprises a recess with a projection extending therein.

15. The securement device of claim 11, wherein the first connector set comprises two studs extending from a first surface of the first clip and the second receiver is configured to receive the two studs and retain them via a pressure hold.

16. The securement device of claim 15, wherein the receiver further comprises a recess with a projection extending within the recess.

17. The securement device of claim 11, wherein the first clip further comprises a top and a bottom connected via a hinge and configured to open and close to form a channel therebetween.

18. The securement device of claim 11, further comprising a clamp configured to releasably secure to the first clip.

19. A securement device with a modular clip system, comprising:
a plurality of clips, each of the plurality of clips having:
a connector set positioned on a first surface; and
a receiver positioned on a second surface;
wherein the connector set of a first of the plurality of clips is configured to releasably secure to the receiver of a second of the plurality of clips;
a clamp configured to releasably secure to the plurality of clips;
wherein the plurality of clips are configured to secure into at least two arrangements via the connector set and the receiver of each of the plurality of clips.

20. The securement device of claim 19, wherein the connector set comprises studs and the receiver comprises a recess such that the connector set of the first of the plurality of clips fits into the receiver of the second of the plurality of clips and is retained in the receiver via a pressure hold.
